(19) United States
(12) Patent Application Publication
(10) Pub. No.: US 2024/0219440 A1
(43) Pub. Date: Jul. 4, 2024

(54) Modeling method

(71) Applicant: Compredict GmbH, Darmstadt (DE)

(72) Inventors: Stéphane Foulard, Rödermark (DE); Rafael Fietzek, Darmstadt (DE); Rudolf KRAFT, Darmstadt (DE); Martin ZELLER, Darmstadt (DE)

(73) Assignee: Compredict GmbH, Darmstadt (DE)

(21) Appl. No.: 18/557,929

(22) PCT Filed: Apr. 29, 2022
(86) PCT No.: PCT/EP2022/061431

§ 371 Date: Oct. 28, 2023

(30) Foreign Application Priority Data
Apr. 29, 2021 (LU) 500099

(51) Int. Cl. G01R 23/165

(52) U.S. Cl. CPC G01R 23/165

(57) ABSTRACT

A method for determining feature signal filters for preparing signal measurement data sequences of a plurality of measurement variables for experimentally determining a mathematical model which maps model measurement data for at least one target signal sensor (7) on the basis of detected measurement data of a plurality of feature signal sensors (5) is disclosed. Further disclosed is a method for determining a mathematical model (16) which maps model measurement data for at least one target signal sensor (7) on the basis of detected measurement data of a plurality of feature signal sensors (5), wherein training input measurement data sequences (19) ascertained by the feature signal sensors (5) are mapped onto at least one training output measurement data sequence (18) ascertained by at least one target signal sensor (7).

### CROSS-REFERENCE TO RELATED APPLICATION

This application is a national stage application, filed under 35 U.S.C. § 371, of International Patent Application PCT/EP2022/061431, filed on Apr. 29, 2022, which claims the benefit of Luxembourg Patent Application LU 500099, filed on Apr. 29, 2021.

### BACKGROUND

A sensor is a technical component through which physical or chemical properties are detected and converted into an electrical signal. Sensors can be used for a wide range of measurement tasks, for example to quantitatively measure temperature, acceleration, force, torque or displacement. In complex systems, such as electronic or mechatronic devices, but also in engines or complex production plants, a large number of sensors are usually installed to monitor the system or the processes, as the case may be, taking place. Often, limited installation space makes it difficult to use sensors at suitable locations. Furthermore, the use of sensors in suitable locations is made more difficult due to unfavorable environmental conditions, such as thermal, mechanical, or chemical effects, and due to the resulting wear of the sensors. On the basis of the measurement task, the use is often associated with high costs due to the large number of sensors used.

A simulation of sensors or sensor signals, as the case may be, is used in virtual test environments to replicate and simulate complex systems for virtual tests. The sensor signals can be simulated and calculated sensor signal waveforms or sensor data recorded during a real process.

For the simulation of sensor signals in the real operation of a system, it is known that signals from sensors are used as input signals for a simulation program stored in a control device or for a simulation program stored in a computers system embedded in a real system, in order to calculate a sensor value of a non-existing sensor on the basis of the stored calculation model. In this case, the calculation can be carried out directly on the computer system or on a computer system integrated within a computer network, such as a cloud. The sensor value is usually calculated by evaluating control maps stored in the memory of the control device or computer system, as the case may be. The sensor values ascertained by means of the calculation models on the basis of the control maps may show unsatisfactory matching with the sensor values from the real process. Due to changing environmental conditions or changes in the process characteristic or in the system, further deviations can be caused, resulting in an inaccurate sensor value.

### SUMMARY

The disclosure relates to a method for determining feature signal filters for preparing signal measurement data series of a plurality of measurement variables for experimentally determining a mathematical model that maps model measurement data for at least one target signal sensor on the basis of detected measurement data of a plurality of feature signal sensors. The disclosure also relates to a method for determining a mathematical model that maps model measurement data for at least one target signal sensor on the basis of detected measurement data from a plurality of feature signal sensors.

It is considered to be an object of the present disclosure to improve the processes known from the prior art.

This object is achieved by a method, wherein feature signal measurement raw data series are recorded with the feature signal sensors using a data processing system, wherein feature signal measurement data series are ascertained from the feature signal measurement raw data series using the data processing system, wherein at least one target signal measurement raw data series is recorded with the at least one target signal sensor using the data processing system, wherein at least one target signal measurement raw data series is ascertained from the at least one target signal measurement raw data series using the data processing system, wherein, in a frequency analysis step, a feature amplitude spectrum is ascertained by the data processing system for each feature signal measurement data series by means of a frequency analysis method, and a target amplitude spectrum is ascertained for the target signal measurement data series by means of the frequency analysis method, wherein the feature amplitude spectra are in each case divided into a plurality of mutually adjacent or partially overlapping feature amplitude spectrum sections, wherein the feature amplitude spectrum sections in each case comprise a manually or automatically predetermined feature frequency range, wherein the target amplitude spectrum is divided into target amplitude spectrum sections, wherein target frequency ranges of the target amplitude spectrum sections correspond to the feature frequency ranges, wherein, in a match checking process in a plurality of repetitive match checking steps, in each case a match measure for each feature amplitude spectrum section is ascertained by the data processing system, wherein the match measure is a measure for the matching of the amplitude spectrum of the respective feature amplitude spectrum section and the associated target amplitude spectrum section, wherein the feature frequency ranges, whose match measure exceeds a predetermined match measure number, are selected as selection signal frequency ranges by the data processing system, wherein, in a subsequent determination step for the selection signal frequency ranges, in each case a respective selection band pass filter is designed by the data processing system, such that signal measurement data series filtered with the respective selection band pass filter have signal components lying within the respective selection signal frequency range and signal components lying outside the respective selection signal frequency range are filtered out of the filtered signal measurement data series, wherein each selection band pass filter forms a feature signal filter for each feature signal sensor, with which the match measure between the feature amplitude spectrum section of the feature signal measurement data series recorded by the respective feature signal sensor and the target amplitude spectrum section in the feature frequency range associated with the respective selection band pass filter exceeds the match measure number. In the case of overlapping feature frequency ranges, the feature frequency ranges with the larger match measure are selected. By setting the predeterminable match measure number, a targeted manual selection of feature signal measurement data series or feature frequency ranges, as the case may be, can be performed, such that the feature signal measurement data series that are useful and relevant for the design of the selection band pass filter are selected in a simple manner. With band pass filters, only signals of a certain frequency band within a lower frequency band limit and an upper frequency band limit are allowed to pass. In this case, the frequency ranges above the upper frequency band limit and below the lower frequency band limit are blocked or significantly attenuated. The lower frequency band limit of the selection band pass filter can be selected such that it is at 0 Hz, such that the selection band pass filter forms a low-pass filter. The upper frequency band limit of the selection band pass filter can be selected such that it is at the Nyquist frequency, such that the selection band pass filter forms a high-pass filter.

Feature signal measurement raw data series can also be provided by sources different from sensors. For example, feature signal measurement raw data series can be formed from control device output signals issued by a control device. In this case, the control device input signals are not necessarily formed from sensor signals. For example, a pre-processed control device input signal, which is ascertained by means of a feature signal sensor, can be used to generate rotational speed information as a control device output signal from a count of control device input signal peaks. Feature signal measurement raw data series can also be formed from a simulation model implemented in a control device, wherein torque information can be determined on the basis of control maps stored in the simulation model. Control device output signals formed by plausibility checks of different control device input signals can also be provided, for example, in the form of state variables, so-called Boolean variables, as feature signal measurement raw data series.

An example shown below will serve to illustrate the concepts specified above. Within a real system, for example an engine, a plurality of signal sensors, such as the feature signal sensors and the target signal sensor, are used to measure, for example, pressure, temperature, or a gas volume flow. In this case, for example, two pressure sensors to measure the pressures p1 and p2 and one temperature sensor to measure the temperature T1 are used as feature signal sensors. Furthermore, in the example, the target signal sensor designed as a volume flow sensor is used to measure the volume flow q1. The aim of the modeling method is to create a mathematical model, through which, from the signal waveforms of the pressures p1 and p2 and the temperature T1 ascertained by the feature signal sensors, the signal waveform ascertained by the target signal sensor and correspondingly the volume flow q1 are to be simulated, such that when the mathematical model is used in a similar real system and using the feature signal sensors specified above, the signal waveform of the target signal sensor can be simulated and, if necessary, the use of the target signal sensor can be dispensed with.

The sampling of the signals recorded by the feature signal sensors and the target signal sensor is performed at equidistant temporal intervals, wherein the signals are alternatively or additionally interpolated, such that a plurality of feature signal measurement raw data series and a target signal measurement raw data series are generated by one measured value recording of the signals. Usually, preprocessing of the plurality of feature signal measurement raw data series and the target signal measurement raw data series is performed by low pass filtering, in order to suppress noise components contained therein. Subsequently, a selection of relevant time periods from the feature signal measurement raw data series and from the target signal measurement raw data series is performed, by which in each case a plurality of feature signal measurement data series and a plurality of target signal measurement data series is formed. In this case, the time periods selected are those in which the feature signal measurement raw data series or the target signal measurement raw data series, as the case may be, have the largest possible frequency content and the largest possible dynamic range. The dynamic range can be assessed, for example, based on frequency amplitude spectra ascertained by means of the frequency analysis method, such as a short-time Fourier transform (STFT for short). By applying the frequency analysis method, the feature amplitude spectra and the target amplitude spectra are ascertained and subsequently divided into individual feature amplitude spectrum sections and target amplitude spectrum sections. In the checking step, the feature amplitude spectrum sections and the target amplitude spectrum sections are checked and compared to determine whether the frequency components contained therein match to a certain degree. For example, the changing frequency components within a feature amplitude spectrum section due to changes in pressures p1 or p2 can be represented by a changing volume flow q1 or as changing frequency components in a target amplitude spectrum section, as the case may be. Since a change in volume flow q1 due to a change in temperature T1 may occur at a longer time interval than due to a change in pressures p1 or p2, a plurality of feature amplitude spectra or feature signal measurement data series, as the case may be, that are different from one another may be relevant for modeling. To ensure that only those frequency components from the feature amplitude spectrum sections classified as relevant are used for modeling, a selection band pass filter is generated for each feature amplitude spectrum section classified as relevant. The input signal measurement data series intended for modeling are filtered with such selection band pass filters and in this way the input signal data series for modeling are generated. Thus, a model is created only with the signal components that have the previously ascertained relevant frequency components, such that a particularly precise model can be ascertained.

The data processing system used for used to carry out the method can include different data processing devices which carry out sub-steps of the method also at longer time intervals. For example, the feature signal measurement raw data series and the target signal measurement raw data series can be recorded with a data logger and stored in a memory. At a later point in time, these recorded feature signal measurement raw data series and target signal measurement raw data series are accessed by a further data processing device of the data processing system, such as a PC or a cloud server, and the further evaluation steps of the method are carried out.

In an advantageous embodiment, it is provided that the match measure is determined by means of a correlation analysis by the data processing system. Optionally, the root of the averaged error square (so-called root-mean-squared error, RMSE for short) or a standardized root of the averaged error square can be determined as a match measure.

In order to achieve a particularly sharp delimitation of the selection signal frequency range, it is provided in an advantageous implementation that the band pass filter preferably has a filter order of at least eight. Thus, a particularly steep slope can be achieved at the limits of the selection signal frequency range, by which the frequencies lying within and frequencies outside the selection signal frequency range can be separated from one another particularly well.

In addition, it is provided that a band pass filter designed as a so-called Butterworth filter preferably has a filter order of at least four. Other types of filters, such as a finite impulse response (FIR for short) filter, may also be provided.

In an advantageous embodiment of the method, it is provided that the feature amplitude spectrum sections have a predetermined amplitude spectrum width. For example, an amplitude spectrum width can be manually predetermined such that only relevant frequency ranges of the feature amplitude spectra are taken into account, given a certain process understanding of the process to be simulated.

For determining the feature amplitude spectrum sections, it is advantageously provided that the feature amplitude spectrum sections are ascertained by the data processing system in that the feature amplitude spectrum is divided into two feature amplitude spectrum sections in a first sub-step and a first match measure is determined for each feature amplitude spectrum section, and in that subsequently the feature amplitude spectrum sections are in each case further divided into smaller feature amplitude spectrum sections in further sub-steps and the match measure is determined in each case, wherein each feature amplitude spectrum section is divided into new feature amplitude spectrum sections in the further sub-steps until an improvement of the match measure between a preceding sub-step and the current sub-step is smaller than a predetermined improvement value. By applying such a regression tree method in the frequency range, the respective feature frequency ranges can be ascertained particularly easily in an automated manner. Thereby, the match measures for the feature amplitude spectrum sections ascertained in one sub-step are in each case compared in a subsequent sub-step with the match measures ascertained during a further division of the respective feature amplitude spectrum section, and the further division is aborted if no further significant improvement can be achieved by this.

In an advantageous embodiment, it is provided that adjacent feature amplitude spectrum sections overlap by a predetermined amplitude spectrum overlap width, such that relevant frequencies of the feature amplitude spectra are contained multiple times within the feature amplitude spectrum sections. This means that the existing database can be advantageously used. In this case, the amplitude spectrum overlap width can also be zero, such that adjacent feature amplitude spectrum sections are adjacent to one another and do not overlap. The amplitude spectrum overlap width can also be less than zero in order to avoid frequency increases in the areas of the overlapping filter edges.

The object specified above is also achieved by a method for determining a mathematical model that maps model measurement data for at least one target signal sensor on the basis of detected measurement data from a plurality of feature signal sensors, wherein training input measurement data series ascertained by the feature signal sensors are mapped onto at least one training output measurement data series ascertained by at least one target signal sensor, wherein by means of feature signal filters designed in accordance with the method described above, the training input measurement data series are filtered using a data processing system and thereby training input data series are formed, wherein a training input measurement data series can be filtered with differently designed feature signal filters, such that a plurality of training input data series are formed from a training input measurement data series, and wherein the mathematical model is ascertained using the data processing system by means of a data-based model determination method starting from the training input data series as model input variables and the at least one training output measurement data series as the model output variable. By filtering the training input measurement data series by means of the ascertained selection band filters, one or a plurality of training input data series can be generated from one training input measurement data series. This allows the mathematical model to be determined particularly quickly and precisely. Different data-based model determination methods can be used to determine the mathematical model. The mathematical model can be linear or nonlinear. Parametric and non-parametric models can be used. Identification methods, genetic algorithms, neural networks and the like, which are sufficiently known from the prior art, can be used as model determination methods.

The training input measurement data series used for modeling are ascertained by the feature signal sensors. As in the example described above, the training input measurement data series are thus ascertained by the exemplary two pressure sensors and by the temperature sensor. In this case, modeling can also be performed by means of training input measurement data series, which are ascertained in the same process, but on other similar systems. In the other similar systems, the pressure sensors specified above and the temperature sensor are used as feature signal sensors to ascertain the training input measurement data series.

Optionally, it is provided that the training output measurement data series ascertained with the target signal sensor are used as training output data series for modeling by filtering with the corresponding selection band filters.

Once the modeling has been performed, it can be used in a production system of the real system. Alternatively, the model is used on a computer system that operates within a computer network, such as a cloud. Depending on the application, the target signal sensor is no longer present in the real system or the target signal measurement data series are to be supplemented as a redundant calculated signal. For this purpose, the target signal measurement data series of the target signal sensor are approximated by the model output variables determined by the model from the model input variables.

In an advantageous implementation, it is provided that the training input measurement data series are formed by the feature signal measurement data series. This allows easy access to existing feature signal measurement data series, which eliminates the time required to prepare feature signal measurement raw data series for use as training input measurement data series. A combination of feature signal measurement data series or components of feature signal measurement data series and training input measurement data series or sections of training input measurement data series is also provided.

In order to determine the feature signal measurement data series from the feature signal measurement raw data series, it is advantageously provided that the feature signal measurement data series have feature signal measurement data points directly following one another in time and thus in each case form a section of the associated feature signal measurement raw data series, wherein the sections of the feature signal measurement data series have at least one predetermined minimum number of data points and wherein the section is selected by the data processing system such that a target signal power is maximum in the selected section. Target signal power describes the relevant amplitudes contained within the feature signal measurement data series. The larger the amplitudes contained within a corresponding section of the signal or feature signal measurement data series, as the case may be, the greater the target signal power. It is provided that for ascertaining feature amplitude spectrum sections from feature signal measurement data series, a short-time Fourier transform (STFT for short) or a wavelet transform of the feature signal measurement raw data series is carried out. In this case, the sections of the associated feature signal measurement data series are identified by determining a sum of the (squared) residual error of each section from its local mean value. As soon as a significant change in the mean value occurs, the next section is formed, taking into account the predetermined minimum number of data points. In this way, temporal sections of the feature signal raw data series that have a particularly large frequency content or a particularly high dynamic range or a high dynamic range and a high target signal power, as the case may be, can be identified.

In an advantageous embodiment, it is provided that, in order to determine the target signal power for a target signal measurement raw data series for successive and advantageously overlapping time periods with a predetermined time duration of the target signal measurement raw data series, a short-term frequency amplitude spectrum is ascertained by the data processing system for each target signal measurement raw data point, wherein a short-term frequency amplitude power is determined for each short-term frequency amplitude spectrum, wherein target signal measurement raw data points following one another in time are combined into target signal measurement raw data sections by the data processing system in such a way that a change in the short-term frequency amplitude power of target signal raw data points directly following one another in time is below a predetermined change power, and wherein subsequently in each case a target signal power is formed by the data processing system for all combinations of target signal raw data sections following one another in time that have the predetermined minimum number of data points and wherein the combination is selected as section by the data processing system whose target signal power is maximum. By selecting the target signal measurement raw data points with maximum target signal power, a particularly precise determination of the selection band filters and the mathematical model can be performed.

The following example illustrates the ascertainment of the target signal power. For the design of the filter, a minimum step frequency and a maximum upper frequency are initially defined. For example, the minimum step frequency can be set at 1 Hz and the frequency M can be set for the maximum frequency. Subsequently, individual feature signal measurement data series are formed by the frequency range sections 0 Hz to 1 Hz, 0 Hz to 2 Hz, . . . , 0 Hz to M Hz, 1 Hz to 2 Hz, 1 Hz to 3 Hz . . . , 1 Hz to M Hz, . . . , (M−1) Hz to M Hz. For the target signal measurement data series and all individual feature signal measurement data series, a Fourier spectrum is ascertained in each case by means of a standard fast Fourier transform analysis. Subsequently, the correlation coefficients between the Fourier spectra of the target signal measurement data series and the feature signal measurement data series are determined on all individual frequency range sections defined above (0 Hz to 1 Hz, 0 Hz to 2 Hz, . . . 0 Hz to M Hz, 1 Hz to 2 Hz, 1 Hz to 3 Hz . . . , 1 Hz to M Hz, . . . , (M−1) Hz to M Hz). Only feature signal measurement data series or frequency range sections, as the case may be, with the highest correlation coefficients are further taken into account. For example, these can be the frequency range sections 0 Hz to 1 Hz, 1 Hz to 6 Hz, 6 Hz to 8 Hz and 8 Hz to M Hz. In this case, the entire frequency range from 0 Hz to M Hz is covered with p frequency range sections, wherein no frequency range section is neglected and frequency range sections with low correlation coefficients are also taken into account. However, it is optionally also provided that frequency range sections that have a low correlation value and lie below a predetermined correlation limit value are neglected. Through the described procedure, n feature signal measurement data series that have the largest correlation coefficient on the respective frequency range section are selected. The filters are then designed for the selected feature signal measurement data series. If the number of frequency range sections p is equal to the number of selected feature signal measurement data series n, all defined frequency range sections are considered and exactly one feature signal measurement data series per frequency range section is considered. If the number of selected feature signal measurement data series n is smaller than the number of frequency range sections p, only the frequency range sections of the n selected feature signal measurement data series with the highest correlations are considered. Thus, a feature signal measurement data series is considered for each frequency range section. The remaining frequency range sections are neglected. If the number of selected feature signal measurement data series n is greater than the number of frequency range sections p, a plurality of feature signal measurement data series per frequency range section can be considered.

In an advantageous embodiment, it is provided that in order to determine the target signal power for a target signal measurement raw data series for successive and advantageously overlapping time periods with a predetermined time duration of the target signal measurement raw data series, a short-term frequency amplitude spectrum is determined by the data processing system, wherein the determined short-term frequency amplitude spectra are arranged chronologically in a short-term frequency amplitude spectrum matrix, wherein a mathematical convolution operation with a frequency weighting matrix is then applied to the short-term frequency amplitude spectrum matrix by the data processing system, so that as a result a weighting value time series is formed, which is used as the target signal power. The short-term frequency amplitude spectrum matrix comprises, for example, m rows with the frequency amplitudes determined at m frequencies and n columns which correspond to the time periods for which the frequency amplitudes were determined, for example, using the STFT method. The frequency weighting matrix is advantageously a matrix which also has m rows. The number of columns k of the frequency weighting matrix is predetermined and determines a width of the time period for which a weighting value is formed. The frequency weighting matrix can be specified in such a way that certain frequency ranges are incorporated more heavily into the weighting value formed by the convolution operation than others.

Further advantageous embodiments of the method are explained with reference to exemplary embodiments shown in the drawings.

### BRIEF DESCRIPTION OF THE DRAWINGS

FIG. 1 is a schematic representation of feature signal measurement raw data series and target signal measurement raw data series and the feature amplitude spectra and target amplitude spectra ascertained by means of the frequency analysis method.

FIG. 2 is a schematic representation of training input data series used for the determination of the mathematical model as model input variables and the training output measurement data series as the model output variable.

### DETAILED DESCRIPTION

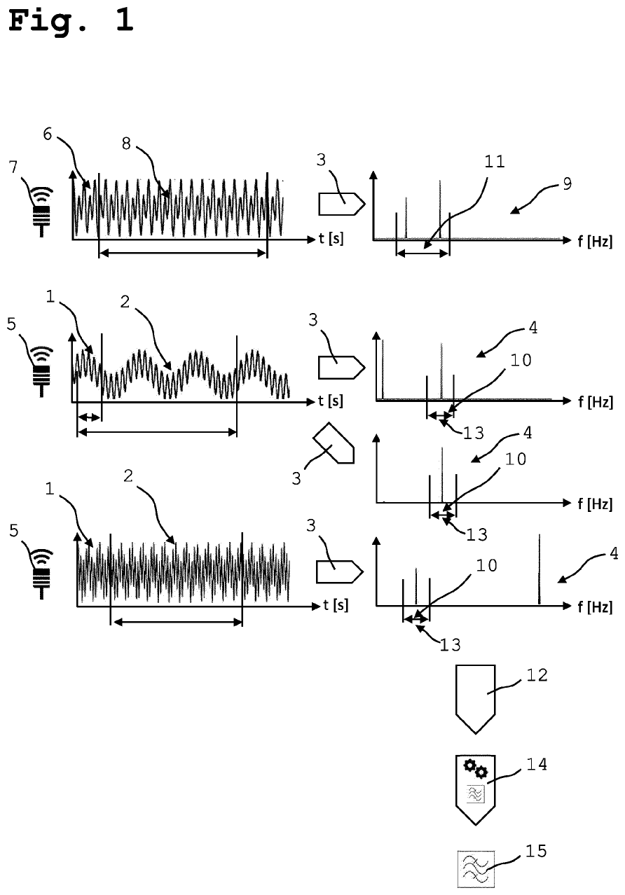

FIG. 1 shows a schematic representation of feature signal measurement raw data series 1 and target signal measurement raw data series 2 and feature amplitude spectra 4 ascertained by a frequency analysis step 3. The feature signal measurement raw data series 1 are determined using feature signal sensors 5. Feature signal measurement data series 2 are ascertained from the feature signal measurement raw data series 1. The at least one target signal measurement raw data series 6 is determined using a target signal sensor 7. At least one target signal measurement data series 8 is ascertained from the target signal measurement raw data series 6. In the frequency analysis step 3, a feature amplitude spectrum 4 is ascertained for each feature signal measurement data series 2 by means of a frequency analysis method, and a target amplitude spectrum 9 is ascertained for each target signal measurement data series 8. The feature amplitude spectra 4 are each divided into a plurality of feature amplitude spectrum sections 10 that are adjacent to one another or partially overlap, in each case comprising a predetermined feature frequency range. The target amplitude spectrum 9 is divided into target amplitude spectrum sections 11, wherein target frequency ranges of the target amplitude spectrum sections 11 correspond to feature frequency ranges. In a match checking process 12, a match measure for each feature amplitude spectrum section 10 is ascertained in each of a plurality of repetitive match checking steps, wherein the match measure is a measure for the matching between the amplitude spectrum of the respective feature amplitude spectrum section 10 and the associated target amplitude spectrum section 11. The feature frequency ranges whose match measure exceeds a predetermined match measure number are selected as selection signal frequency ranges 13. In a subsequent determination step 14, in each case a selection band pass filter 15 is designed for the selection signal frequency ranges 13, such that signal measurement data series filtered with the respective selection band pass filter 15 have signal components lying within the respective selection signal frequency range 13 and signal components lying outside the respective selection signal frequency range 13 are filtered out of the filtered signal measurement data series.

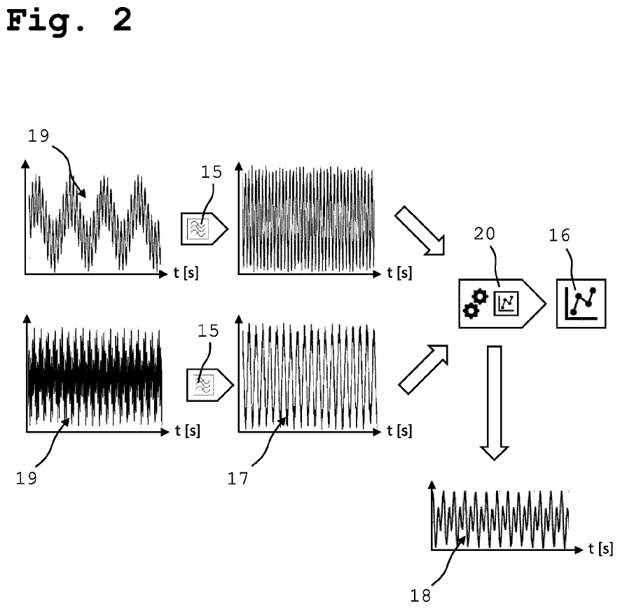

FIG. 2 shows a schematic representation of training input data series 17 used for determining a mathematical model 16 as model input variables and the training output measurement data series 18 as model output variables. Using the designed selection band pass filter 15, the training input measurement data series 19 ascertained by the feature signal sensors 5, which can also be formed by the feature signal measurement data series 2, are filtered, by which training input data series 17 are formed. The training input measurement data series 19 filtered with the respective selection band pass filter 15 have signal components lying within the respective selection signal frequency range 13. Signal components lying outside the respective selection signal frequency range 13 are filtered out of the filtered training input measurement data series 19. In this case, a training input measurement data series 19 can be filtered with differently designed selection band filters 15, such that a plurality of training input data series 17 are formed from one training input measurement data series 19. By means of a data-based model determination method 20, the mathematical model 16 is ascertained starting from the training input data series 17 as model input variables and the at least one training output measurement data series 19 as a model output variable.

1.-10. (canceled)

11. A method for determining feature signal filters for preparing signal measurement data series of a plurality of measurement variables for experimentally determining a mathematical model (16) that maps model measurement data for at least one target signal sensor (7) based on detected measurement data of a plurality of feature signal sensors (5), comprising:
recording feature signal measurement raw data series (1) with the feature signal sensors (5) using a data processing system;
ascertaining feature signal measurement data series (2) from the feature signal measurement raw data series (1) using the data processing system;
recording at least one target signal measurement raw data series (6) with the at least one target signal sensor (7) using the data processing system;
ascertaining at least one target signal measurement data series (8) from the at least one target signal measurement raw data series (6) using the data processing system;
ascertaining, in a frequency analysis step (3), a feature amplitude spectrum (4) by the data processing system for each feature signal measurement data series (2) by a frequency analysis method and ascertaining a target amplitude spectrum (9) for the at least one target signal measurement data series (8) by the frequency analysis method;
dividing each feature amplitude spectrum (4) into a plurality of mutually adjacent or partially overlapping feature amplitude spectrum sections (10), wherein the feature amplitude spectrum sections (10) each comprise a manually or automatically predetermined feature frequency range;
dividing the target amplitude spectrum (9) into target amplitude spectrum sections (11), wherein target frequency ranges of the target amplitude spectrum sections (11) correspond to the feature frequency ranges;
ascertaining, in a match checking process (12) in a plurality of repetitive match checking steps, in each case a match measure for each feature amplitude spectrum section (10) by the data processing system, wherein the match measure is a measure for the matching of the amplitude spectrum of the respective feature amplitude spectrum section (10) and an associated target amplitude spectrum section (11);
selecting the feature frequency ranges whose match measure exceeds a predetermined match measure number as selection signal frequency ranges (13) by the data processing system; and
designing, in a subsequent determination step (14) for the selection signal frequency ranges (13), in each case a respective selection band pass filter (15) by the data processing system, such that signal measurement data series filtered with the respective selection band pass filter (15) have signal components lying within the respective selection signal frequency range (13) and signal components lying outside the respective selection signal frequency range (13) are filtered out of the filtered signal measurement data series,
wherein each selection band pass filter (13) forms a feature signal filter for each feature signal sensor (5), with which the match measure between the feature amplitude spectrum section (10) of the feature signal measurement data series (2) recorded by the respective feature signal sensor (5) and the target amplitude spectrum section (11) in the feature frequency range associated with the respective selection band pass filter (13) exceeds the match measure number.

12. The method according to claim 11, further comprising:
determining the match measure by a correlation analysis by the data processing system.

13. The method according to claim 11,
wherein the band pass filter has a filter order of at least eight.

14. The method according to claim 11,
wherein the feature amplitude spectrum sections (10) have a predetermined amplitude spectrum width.

15. The method according to claim 11, further comprising:
ascertaining the feature amplitude spectrum sections (10) by the data processing system by dividing the feature amplitude spectrum (4) into two feature amplitude spectrum sections (10) in a first sub-step and determining a first match measure for each feature amplitude spectrum section (10);
subsequently further dividing the feature amplitude spectrum sections (10) in each case into smaller feature amplitude spectrum sections (10) in further sub-steps and determining the match measure in each case; and
dividing each feature amplitude spectrum section (10) into new feature amplitude spectrum sections (10) in the further sub-steps until an improvement of the match measure between a preceding sub-step and a current sub-step is smaller than a predetermined improvement value.

16. The method according to claim 11,
wherein adjacent feature amplitude spectrum sections (10) overlap by a predetermined amplitude spectrum overlap width.

17. A method for determining a mathematical model (16) that maps model measurement data for at least one target signal sensor (7) based on detected measurement data from a plurality of feature signal sensors (5), comprising:
mapping training input measurement data series (19) ascertained by the feature signal sensors (5) onto at least one training output measurement data series (18) ascertained by at least one target signal sensor (7); and
filtering, by feature signal filters designed in accordance with claim 11, the training input measurement data series (19) using a data processing system and thereby forming training input data series (17),
wherein a training input measurement data series (19) can be filtered with differently designed feature signal filters, such that a plurality of training input data series (17) are formed from a training input measurement data series (19), and
wherein the mathematical model (16) is ascertained using the data processing system by a data-based model determination method (20) starting from the training input data series (17) as model input variables and the at least one training output measurement data series (18) as a model output variable.

18. The method according to claim 17, wherein the training input measurement data series (19) are formed by the feature signal measurement data series (2).

19. The method according to claim 17,
wherein the feature signal measurement data series (2) have feature signal measurement data points directly following one another in time and thus in each case form a section of the associated feature signal measurement raw data series (1),
wherein the sections of the feature signal measurement data series (2) have at least one predetermined minimum number of data points and
wherein the section is selected by the data processing system such that a target signal power is maximum in the selected section.

20. The method according to claim 19, further comprising:
ascertaining, in order to determine the target signal power for a target signal measurement raw data series (6), a short-term frequency amplitude spectrum by the data processing system for each target signal measurement raw data point;
determining a short-term frequency amplitude power for each short-term frequency amplitude spectrum;
combining target signal measurement raw data points following one another in time into target signal measurement raw data sections by the data processing system in such a way that a change in the short-term frequency amplitude power of target signal raw data points directly following one another in time is below a predetermined change power; and
subsequently forming in each case a target signal power by the data processing system for all combinations of target signal raw data sections following one another in time that have the predetermined minimum number of data points; and
selecting the combination as section by the data processing system whose target signal power is maximum.
